(19) United States
(12) Patent Application Publication
(10) Pub. No.: US 2003/0177706 A1
(43) Pub. Date: Sep. 25, 2003

(54) Mounting system for supporting objects

(76) Inventor: Stanley A. Ullman, Camarillo, CA (US)

Correspondence Address: RALPH D CHABOT, 2310 E PONDEROSA DR, SUITE 4, CAMARILLO, CA, 93010, US

(21) Appl. No.: 10/394,609

(22) Filed: Mar. 21, 2003

Related U.S. Application Data
(63) Continuation-in-part of application No. 10/104,131, filed on Mar. 21, 2002.
Application No. 10/104,131 is a continuation-in-part of application No. 09/758,407, filed on Jan. 10, 2001, now Pat. No. 6,360,491.
(60) Provisional application No. 60/176,126, filed on Jan. 14, 2000.

(51) Int. Cl. E04B 1/34; B62D 63/04

(52) U.S. Cl. 52/3

(57) ABSTRACT

A new mounting system for elevating and supporting objects such as solar panels and satellite dishes either upon the roofs of commercial buildings. The mounting system utilizes a modified “C” channel having a plurality of longitudinal grooves for engaging mating flanges. The purpose of this equipment is to provide a rigid, stable platform for mounting equipment upon commercial buildings which have rafter spacing much greater than for residential roofs.

### CLAIM OF PRIORITY

This is a continuation-in-part application that claims the benefit of U.S. patent application bearing Ser. No. 10/104,131 filed Mar. 21, 2002 which claims the benefit of U.S. patent application bearing Ser. No. 09/758,407 filed Jan. 10, 2001 (now U.S. Pat. No. 6,360,491) which claimed priority to U.S. Provisional Application bearing serial No. 60/176,126 filed Jan. 14, 2000.

### TECHNICAL FIELD

The present invention relates to the building industry and specifically to mounting equipment and a method for supporting an object over a roof or above ground.

### BACKGROUND OF INVENTION

This background incorporates the disclosure from the previous two utility applications referenced above. The additional background information pertaining to the new matter presented in this application is identified below.

Mounting equipment sometimes referred to herein as a mounting system, is used to attach objects such as solar panels including photovoltaic (PV) modules and solar pool heating panels, solar heating collectors (referred to sometimes as domestic hot water collectors), satellite dishes, air conditioning units, etc. The mounting equipment is typically fastened at its base end to either a foundation, directly to the earth, or to support structures on a building such as roof rafters.

The roofs of building structures have been used for placement of objects with the primary reason for location upon a roof are the lack of alternative space.

Air conditioning units, because of their relative heavy weight, provide a downward force upon the roof in any weather condition. However, a problem exists for other objects such as satellite dishes and solar panels, which can, in certain windy conditions, be lifted off the mounting equipment to which they are attached because the force of the wind applied against the surface area on the side or underside of the object creates an uplift condition which is greater than the attachment strength of the mounting equipment.

Besides the need for compliance with governmental building code requirements, a more time efficient method for installing a mounting system, particularly to a roof, is highly desired by installers. A faster installation reduces the labor costs associated with each install.

One of the problems with present installations is the fact that more than one lag bolt or other type of fastening bolt is required for each mounting plate that is fastened to the roof. The risk is high that some of the lag bolts will drill at an angle other than perpendicular to the roof rafter. The severity of the angle and the trajectory of the lag bolt penetration into the rafter could cause the rafter to split; further reducing the structural integrity of the mounting system.

For many years, existing solar mounting systems were installed using a threaded pipe nipple that screwed into a mounting plate commonly called a “floor flange” in the trade. The threaded floor flange has been commercially available as a standard plumbing item for many years. U.S. Pat. No. 5,603,187 issued to Merrin et al. is typical of the prior art.

The Merrin design, as well as similar prior art, have a common design limitation. They require multiple bolts be installed offset from the threaded vertical support flange or stanchion. Also, because of the floor flange design, it would not permit industry standard flashing to install flat on the roof; primarily due to the base flashing circumference interfering with the height of the floor flange.

A mounting system based upon the Merrin patent, while appropriate for roof mounting of heavy objects such as air conditioners, is not practical for use with lighter objects such as solar panels or satellite dishes. The Merrin design precludes direct (bolted) attachment to the roof rafter by each of the mounting holes present on the base plate; primarily due to the width of the rafter in relation to the spacing of the mounting holes. Further, Merrin views rafter attachment as a limitation and therefore teaches away from using rafters for structural support. Therefore, Merrin teaches attachment to the roof decking which generally consists of only ½ ″plywood or composite sheeting; either of which does not provide the strength of a bolt mounted to a rafter in an uplift condition.

### BACKGROUND PERTAINING TO THE NEW MATTER PRESENTED

Most module support rails for rooftop installation have been designed and engineered for use on residential roofs. Residential roofs have rafters spaced apart by relatively short distances. Because of this, support rails can be structurally attached to more rafters for a given length of support rail than can be the case for commercial roofs. The more attachments a module support rail has to the rafters minimizes mid span deflection especially when relatively lightweight support rails are used.

Commercial roofs, on the other hand, are constructed differently than residential rooftops in that much greater spans exist between rafters. Consequently, fewer rafters are available to secure a given length of support rail to a commercial roof than for a residential roof. Therefore, to achieve a structurally safe installation and provide an acceptable rate of deflection of the support at these greater spans, the installer must either: a) dramatically increase the size and depth of the support rail; or, b) add additional structural members to bring this deflection to an acceptable level. Unfortunately, doing either dramatically increases material and labor costs.

Many photovoltaic (PV) solar panel structures typically use one or more bolts or “L” brackets which lock the support rails in place. Although this method is adequate for residential rooftops, use upon commercial rooftops, particularly when only two support beams are available for attachment, creates a “hinge point” which can cause the support rail to undesirably move when there is a change in load. This situation is not a problem when the span between roof attachments is short but does become a problem with longer lengths of support rails.

A recent prior art product incorporates the use of a specially designed elongated “C” member which incorporates along each elongated side a channel running substantially the length of the “C” member. Each channel is sized to operably permit a bolt head to be slidably positioned within each channel. With the bolt head within the channel, the threaded stem extends outward and provides a means for operably attaching to a vertical support member which is in turn operably secured to the roof. This type of attachment causes the elongated “C” member to be attached in tension to the vertical support member.

The principal drawback to this design is that the bolt head creates a “hinge point” which can permit the channel member to rotate about this hinge point relative to the vertical support member. This situation can occur particularly when additional load is applied upon the structure.

Another drawback to the bolt head attachment design is that the semi-closed groove utilized prevents water from being able to freely drain from the support rail at the moment of structural attachment. Also, the roof top is a polluted environment and in time dirt and other debris will eventually make there way into the semi-closed groove. This condition will be aggravated because a bolt head design blocks or impedes water flow out of the restricted channel. In colder climates, rain water or melting snow during the daytime will freeze at night. The freezing water, if trapped in the restricted groove will expand, stressing the metal which may cause splitting or structural failure of the support rail at the moment of structural attachment.

The bolt head attachment described above offers no structural strength particularly to resist side to side movement. Again, the vertical post or support could collapse under load unless fitted with additional bracing.

The bolt head attachment design utilizes a simple bolt head which can slide in a slotted channel where it is then positioned and then tightened in place. Again, this creates a structural hinge point which cannot reduce or minimize deflection along the span of the support rail or vertical support.

Additional load occurs when a vertical member such as a support tube is leveraged against the support rail in high wind conditions or when substantial snow load is present. Under these load conditions, the support rail and hinged vertical support member will simply torque or twist causing excess deflection of the support rail and/or possible failure.

Another problem is that in some designs, the vertical support legs are off center relative to the weight of the entire mounting structure.

If the vertical member were to shift because of the mounting structure load or because of high winds or excess snow upon said structure, buckling of the entire mounting structure could occur leading to collapse.

Solar panels are sometimes installed on rooftops and angled for optimum position with the sun. To obtain this angle, during the installation procedure the support rails can be either: a) installed after the angled racking is set in place; or, b) in the flat position and then raised (angled) to the proper level and thereafter secured.

The desired procedure is to install upon a flat roof in the horizontal position and then raise the assembled unit to the final angled position. This desired procedure would locate attachment points before the solar panel assembly is raised into position thereby making it much safer and less labor intensive.

Another benefit for raising the assembled unit into position is that the vertical alignment of the posts could be easily accomplished early in the assembly process.

A final issue with installing mounting structures upon a roof top is that the rooftop may not be level. Installing the same mounting plates across a roof which has an uneven surface could undesirably lead to a solar panel assembly installation having its support members stressed or resulting in a pulling on the support beams to achieve alignment when attaching to a base mount.

### SUMMARY OF INVENTION

Incorporated herein is the summary from the previous two utility applications referenced above. A Summary of Invention pertaining to the new matter presented in this application is identified below.

This invention presents a mounting system for supporting objects such as solar panels and satellite dishes. Also claimed is an end clamp that provides superior frictional engagement of the object to the mounting equipment.

Definitions

Alignment Means—a means to align a roof mount such as a guide tunnel.

Fastening Means—a means to fasten the base mount portion of the mounting equipment to a roof rafter, or ground racking system.

Support Means—a term used to collectively refer to the various parts necessary to support an object. Support means includes one or more horizontal members upon which the weight of an object will be supported, and clamps to secure the object to the horizontal member(s).

Attachment Means—Means by which the support means is attached to the base mount. One example is by the use of a bolt threadably engaging a stanchion located on the opposite side of a horizontal member. The base portion of the stanchion is threaded into the base mount.

Securing Means—Means to secure the object upon the horizontal member(s). The securing means comprises either a pair of end clamps each having a raised distal heel, or a wedge or half-moon washer and substitute for a heel and used with end clamps having no heel. The securing means is secured to the adjacent horizontal member and, as tightened, it frictionally engages a portion of the object to maintain it in a secure position upon the horizontal member.

The mounting equipment comprises at least one base mount and associated support clamps and support rails, and is not limited to roof top installations. They can be installed over pipe supports or attached to other support systems or ground racking systems. Types of ground racking systems include, but are not limited to pipe supports, pole mounted installations, building facades and patio covers.

### FIRST EXAMPLE

By way of a first example, for new construction or reroofing, a roof mount would be attached prior to installation of the roof flashing. The component parts for supporting a solar panel or satellite dish would be assembled and attached to the roof mount over the flashing. Features of the invention are as follows:

1. a new base mount (also referred to as a roof mount) having a threadable elongated member or stanchion which requires a single lag bolt positioned directly beneath the stanchion for fastening to a roof rafter. A guide tunnel is also provided on the roof mount for proper drill angle into the rafter.

2. A support design comprising either a composite or aluminum extruded horizontal members and associated equipment for attachment to a plurality of roof mounts which will support a mounted object such as a solar panel. Although a particular C-shaped design is depicted in the drawings, any design to facilitate the securing means is considered to be part of the support design. The purpose of the horizontal members is to provide: 1) support for the weight of an object positioned upon the member; and, 2) to facilitate the securing means of the object to the member by the use of a pair of end clamps for each member used.

3. A securing means for securing the end of a supporting object to the support design. One example of the securing means is a pair of cooperating end clamps each having a raised heel which enhances frictional engagement when being secured into position upon a horizontal member with an object to be secured there between.

### SECOND EXAMPLE

In a second example, the mounting system, instead of being fastened to a new roof rafter for support, is operatively fastened either: a) upon existing roofs or framework; or, b) over pipe supports or other support systems not necessarily located upon a roof. Here, the roof mount referred to earlier is not utilized although the other features described in paragraphs 2, 3, and 4 above pertain. For this example, the roof mount is replaced as the means to fasten the mounting system with an alternative means such as that described in U.S. Pat. No. 5,746,029 issued to Ullman and which is herein incorporated by reference.

Roof Mount (For Example 1)

In order to utilize my mounting system, a roof mount must first be fastened to a rafter. The roof mount can be manufactured from any material commonly used in the building trade to support objects upon a roof. Preferably, the mount is machined from aluminum and comprises a threaded cavity with an insertion opening for threadably receiving a vertical stanchion. Directly below the cavity is an aperture for insertion of a lag bolt for attachment to the rafter. This is a unique feature of my support base. Only one lag bolt or other type of fastening bolt is required. For a one bolt design, having the attachment force positioned directly beneath the stanchion provides the highest level of attachment strength.

Additionally, a special hollow can be machined at the base of the channel to allow clearance for the bolt head when installed so that it does not contact the bottom surface area of the stanchion. This permits maximum threadable engagement of the stanchion to the base.

The base section of the roof mount comprises a base for direct contact with the decking surface of a roof and a vertically extending cylindrical member having the threaded cavity and an offset wall having a guide tunnel. It is not necessary that the guide tunnel be part of the cylindrical member. It is however, preferable to maintain a minimum distance between channel and guide tunnel so that it is easy to use the guide tunnel to drill a pilot hole into a rafter and to thereafter align the pilot hole with the aperture by sliding the base section a minimal distance.

The distance between the cavity and guide tunnel however, must be sufficient so as not to compromise the overall structural integrity of the base section.

In an alternative design, the guide tunnel is not used and the roof mount base section simply incorporates my single bolt design described above which includes a base and a vertically extending cylindrical member having the threaded cavity.

The base can be of any geometrical shape such as circular, rectangle or square. All that is required is that the geometrical shape be sized accordingly so that it does not interfere with the alignment or use of commercially available flashing to the roof.

Once the lag bolt is fastened to the rafter, one end of the stanchion is screwed into the threaded cavity and the roof flashing is thereafter installed. For purposes of this specification, the base section and the stanchion/elongated member are collectively referred to as the roof mount. Although the mounting equipment may be installed days later, it is preferable to install the roof mount at this point.

Installation of Mounting System Upon Support Means

At least one horizontal member is provided as a means for supporting an object. The number of horizontal members used will be dependent upon the type of object to be supported.

The horizontal member is preferably made from extruded aluminum and can be manufactured to any length. Each horizontal member has a track that can be used by either T-nuts or slidable inserts which have been designed to fit within and slide along this track.

The T-nut has a threaded stem facing upward for engaging a clamp with a nut.

The slidable inserts can be designed to have: 1) a hole for allowing the threaded stem of a screw or the like to pass upwards while the headed end of the screw can not; or, 2) a female threaded hole for cooperative securement with the clamps as will be discussed now.

Clamps are used to grip an edge portion of an adjacent object and secure that object in position once the clamp has been fastened to the adjacent horizontal member. The gripping end of the clamp can have a surface which is flat or serrated. One clamp is provided for each slidable insert or T-nut. The clamp has a hole or aperture and is positioned so that either a fastening bolt can be inserted through and secured to the threaded hole of the threadable insert, or it can be secured to the upward facing threaded T-nut stem or, a threaded stem of sufficient length extends upwards through the aperture in the slidable insert and through the aperture in the clamp. Thereafter, a nut is used to threadably engage the threaded stem and fasten the clamp to the horizontal member.

There are two types of clamps available: end clamps and bi-module clamps.

Bi-module clamps are primarily used for securement of the sides of adjacent objects such as two solar panel modules.

A module is a set of photovoltaic cells while a solar panel is a plurality of modules. End clamps would secure the sides of a solar panel. In any case, bi-module clamps are used to secure the sides of two adjoining solar modules to an adjacent horizontal member.

Each horizontal member uses a pair of end clamps for securement of an object there between such as a solar panel. Each end clamp has a section or end referred to as a lip and preferably has a slight rise or heel on its bottom surface distally positioned from the lip end. The lip has a bottom surface that can be described as a gripping surface for engaging an object.

The slight rise or heel provides functional advantages when securing an object to a horizontal member. First, the slight rise prevents twisting of the end clamp while it is being bolted or secured into position on the horizontal member. Second, when the gripping surface of the lip engages an object, the rise forces the clamp inward at 90 degrees to fully engage the object.

In the case of a solar panel, this design prevents the end clamp from inadvertently separating the module frame from its glass. Also, the rise provides spring tension against the module frame, providing full engagement as the module laminate glass and frame flex under extreme stresses caused by weather conditions such as high wind and snow.

Besides an end clamp having a raised heel portion as described above, an alternative heel means for facilitating the securement of an object between two end clamps can be by more than one piece performing the same function such as a wedge or half-moon shaped washer positioned between an end clamp having no heel and the adjacent horizontal member. The purpose of the wedge or washer would be to angle the end clamp the same as if the end clamp had a raised heel portion. However, the single unitized piece is the preferred embodiment.

The heel design incorporated into the end clamp can be of any length or shape. It does not have to be continuous across the extrusion so long as it can function to place inward pressure against an object to be secured between an end clamp and another end clamp or bi-module clamp.

As stated earlier, the securing means, besides using a pair of end clamps having respective heels, can also employ a heel means located between each end clamp not having a heel and the horizontal member. The heel means can be, but should not be considered limited to, the use of a wedge or half-moon shaped washer or other protrusion that, when positioned between the bottom side of the end clamp and the top surface of the horizontal member, will provide the same inward force against the object when tightened to the horizontal support rail.

The support system includes the horizontal members, slidable inserts or T-nuts, end clamps, optional bi-module clamps and the attachment means.

### SUMMARY OF INVENTION PERTAINING TO THE NEW MATTER PRESENTED

The invention is a method for attaching items such as solar modules to commercial rooftops which have greater spacing between rafters than is the case for residential rooftops. In the case of installations which are angled relative to the roof surface, my method also prevents failure associated with additional load which may occur at hinge points.

Because of the longer distances between each support beam for commercial rooftops, it may be necessary to modify the base section of the roof mount previously disclosed in U.S. Pat. No. 6,360,491 to incorporate a sufficiently larger base area for inclusion of an additional hole to accommodate a second bolt attachment to the support beam. This may be necessary in situations where excessive load upon a support module requires the second attachment on the roof mount to adequately support the load. It is to be understood that the second bolt attachment is auxiliary and that the principal support will come from the bolt attachment positioned directly below the stanchion.

My method comprises the use of module support rails. Previously described was the preferred embodiment which uses elongated “C” channels for securing solar panels therebetween. However, besides elongated “C” channels, other designs for the module support rails of this invention can be: “I” shaped beams, square tubes, “H” channels or a “C” channel modified to have a member extending from side to side to create a hollow cavity.

The module support rails of my invention are also fabricated with two elongated slots having tapered sides running along the lower side of a “C” support extrusion. These elongated slots facilitate the engagement of specially designed mating flanges.

As defined herein, “elongated slot” connotes a substantially uniform tapered slot. The tapered slot design increases gripping efficiency when the flanges are tightened.

Another difference between the prior art bolt head attachment and my design is that my design utilizes a compression means of attachment while the bolt head attachment design utilizes a tensional means for attachment.

The purpose of the elongated slots is to operatively secure or rigidly lock the support rail to the vertical support members using mating flanges. The installation of these mating flanges greatly enhances the strength of the support rail while dramatically minimizing the deflection under load.

Where the solar panels are to be angled and installed upon a commercial roof, the horizontal support members used are not the same as the extruded aluminum members described above for flat, or non-angled installations.

Rather, the horizontal support members used are readily available and typically referred to in the construction industry as channel struts. These struts are made of steel because a steel member can resist deformation under load across a longer length than aluminum.

In actual practice, the horizontal support members are attached to the commercial roof rafters in the manner described earlier. In a preferred embodiment, a channel support extension is operatively positioned between the stanchion and channel strut to provide enhanced stability.

Because of the significant number of PV modules to be installed upon a commercial roof, this operation is usually performed prior to PV modules being hoisted upon a roof.

A pair of channel struts can be used for attaching a plurality of solar panels. One channel strut will typically support a pair of support legs for each solar panel. One channel strut will have a longer pair of support legs than the other strut. This length difference accounts for the desired angle of the solar panel installation.

Each support leg is operatively attached to their corresponding channel strut by the use of a lower support bracket which, in a preferred embodiment, has a serrated bottom surface for enhanced frictional contact with the channel strut as it is secured in place. The support leg has a pair of apertures having a common axis of symmetry with corresponding apertures on the lower support bracket to facilitate operable attachment by using a threaded bolt or the like.

The top portion of each support leg is bolted to a pair of flange brackets mounted on opposing sides. Each flange bracket is comprised of a thicker top section and a thinner lower section. The lower sections of corresponding flange brackets are bolted to a support leg. In a preferred embodiment, each flange bracket has a serrated surface opposing the support leg to enhance frictional engagement when securely bolted.

The upper section of each flange bracket has a lip along its entire length and is sized to slidably engage a respective elongated slot present on the module support rail as described earlier.

To facilitate an efficient operation, solar panels are typically hard wired off site and installed upon the module support rails prior to being transported to the installation site.

The solar panels and module support rails are then hoisted upon the commercial roof. For each solar panel, a corresponding pair of long and short support legs is each raised to a vertical position.

The elongated slots of the each module support rail are fitted to the lip of each flange bracket. Once the two lips are operatively within a respective elongated slot and across from one another, the pair of flange brackets are then bolted together and then to the upper end of a respective support leg. Since the lip portion is designed to snugly fit within an elongated slot, the design avoids the creation of a hinge point thereby providing a more secure and stable attachment.

In a typical commercial rooftop installation, there will usually be two sets of channel struts to support a plurality of solar panels that comprise a solar panel array. Each channel strut set will comprise a plurality of channel struts positioned in series.

With respect to installing equipment upon a rooftop having an uneven pitch or a flat roof which sags up and down, after the roof mount and stanchions have been positioned for supporting either end of a channel strut set, a threaded stud is inserted into a respective stanchion. A first nut is threaded onto each stud. Then, with the initial two roof mounts and stanchions affixed to the roof support beams, a string line is run to both first nuts. Then the intermediate roof mounts and stanchions are affixed to respective support beams located between both end roof mounts.

Once each of these intermediate roof mounts and stanchions are affixed to the roof, the first nut associated with each intermediate stanchion is adjusted upon the stud so that its position is level according to the adjacent string line. Once all first nuts for a channel strut set have been adjusted, each channel strut of the set is appropriately positioned so that studs will extend through an adjacent slot present in the bottom wall of each channel strut. Once the studs extend through the adjacent slot, a second nut and first washer for each stud is provided for operable engagement to secure the channel strut to a respective stanchion. In this way, any unevenness present along the channel strut set is compensated for by adjustment of the first nuts as necessary.

The following are highlights of my improvement:

1. The addition of the flange brackets further enhances strength, by adding two additional plates of metal to the angled connection.

2. The tapered design of the flange bracket allows for limited movement to fully engage the vertical support member as well as the groove to adjust for varying tolerances of the extrusion. The support extrusions and mating flanges are designed to engage the parts and allow for future tolerance variations associated with normal extrusion die wear. Because of the special taper, full engagement will occur if reasonable tolerances are held.

3. The installation of the flanges make the connections wider (width from vertical) enhancing strength from side motion as well as hinge motion. Flanges increase the rear axis support of the vertical leg on the opposing axis of load. This feature provides vertical strength under load without the necessity of rear diagonal bracing (rear side movement).

4. Because the sides of the mating flanges will frictionally engage the support channel of the module support rail, this will make the angled connection monolithic and function similar to the truss connection of a pre-fabricated roof truss.

5. The module support rail elongated slot is tapered to increase gripping efficiency when a pair of flange brackets is secured. Because tolerances between the module support rail and support tube will always be different, the tapered flange bracket design allows the flange bracket to bend or deflect slightly to make up for these different tolerances. This design feature allows thinner part of the flange to bend slightly to fully engage the support tube.

6. The use of flange brackets provide a stronger means of attachment than bolting into the support extrusion because the flange brackets provide a compressive force upon the module support rail.

7. The flange bracket design prevents water from trapping in the connection which could result in freeze damage to the module support rail.

8. Placement of the elongated slots at the lower corners of the profile will provide the most strength. The corner of any structural shape is the strongest part of the profile. Compression and gripping at this location increases the strength of the connection and minimizes deflection or bending of the profile.

9. Flanges are designed to provide a compressive force on the module support rail which is much stronger than a hex bolt pulling away from the support channel. Making connections to two or more structural parts, especially when significant stresses are to be expected can be greatly enhanced by a compression connection as oppose to a single bolt. Use of a single bolt in a closed channel creates enormous stresses at the point of hinge (or moment). This point of stress will eventually elongate the softer extrusion and cause failure. This is especially true when dealing with relative soft materials such as aluminum extrusion or other composite materials.

10. Lower (shorter) vertical support legs installed with the flange brackets have two benefits: 1) The PV modules and module support rail can be elevated from the roof to allow for existing roof obstructions such as pipes and conduits; 2) The lower support legs provide a means for the module support rail to be attached at point other than the absolute end of the rail. This feature allows the lower support load to be placed inward from the end of the rail where it is stronger. Without this extension of the lower support, the support rail and modules could not swing up and would hit the roof. Longer support rail spans can be achieved (with minimal deflection) using less supports and lighter support extrusion.

11. My design permits different installation configurations. Rather than having PV modules installed sideways (referred to in the trade as landscape mode), they will often be installed in the vertical position (referred to as portrait) upon commercial rooftops. This fact changes the load stresses of the installation dramatically. It means that the PV modules will be installed much higher, and that the there will be fewer supporting legs to carry the total load of the completed installation. This fact also means that the connections of the support tubes and module support rail will have to absorb increased connection stress loads. Since buildings are much higher and have fewer obstructions to block the flow and velocity of wind, installations on these buildings will be subjected to a higher wind load condition. This also means that support racks must be strengthened to compensate for this, as opposed to similar residential installations.

12. My design would permit installation to any angle between 0 and 90 degrees relative to the roof pitch.

13. Addition of a middle support leg could be added for installations which would encounter either heavy snow load or high wind conditions or when a long support rail span is required.

### BRIEF DESCRIPTION OF DRAWINGS

FIG. 1 is a perspective view and illustrates the position of the base section of the roof mount above a rafter and a drill positioned for drilling a pilot hole.

FIG. 2 is a view taken along line 2-2 of FIG. 1 and which shows a drilled pilot hole.

FIG. 3 indicates the roof mount displaced so that the pilot hole is in alignment with the support channel.

FIG. 4 is an exploded view showing the lag bolt and stanchion relationship to the roof mount.

FIG. 5 is a perspective view when the lag bolt and stanchion are assembled to the roof mount.

FIG. 6 is a view taken along line 6-6 of FIG. 5.

FIG. 7 is a perspective view illustrating the relationship of the assembled roof mount to flashing material.

FIG. 8 is a perspective view of the package comprising a pair of elongated C-shaped members and associated equipment.

FIG. 9 is a view taken along line 9-9 of FIG. 8.

FIG. 9a is an end view of an elongated U-shape member depicting a linear positioning groove for a drill bit to make a hole.

FIG. 10 is a perspective view illustrating the attachment of an elongated C-shaped member to a plurality of stanchions.

FIG. 11 is a perspective view illustrating the slidable relationship of clamps relative to the C-shaped member and the positioning of a solar module.

FIG. 12 is an exploded view of the relationship of an end clamp to a slidable insert.

FIG. 13 is an exploded view of the relationship of a bi-module clamp to a slidable insert.

FIG. 14 is a perspective view of an assembled solar panel having 4 modules.

FIG. 15 is a side view showing a secured end clamp in relationship to the side of a solar panel.

FIG. 16 is a view taken along line 16-16 of FIG. 15.

FIG. 17 is a side view showing a secured bi-module clamp in relationship to the adjacent sides of two solar modules.

FIG. 18 is a view taken along line 18-18 of FIG. 17.

FIG. 19 is a perspective partial view of installation of an object and mounting equipment upon an existing roof utilizing the end clamp of my invention.

FIG. 20 is a perspective partial view of installation of an object and mounting equipment upon pipe supports.

FIG. 21 is a first alternative end clamp to that shown in FIG. 12.

FIG. 22 is a second alternative end clamp to that shown in FIG. 12.

FIG. 23 is an alternative clamping means utilizing a wedge.

FIG. 24 is a first alternative design of a slidable insert to that shown in FIG. 12.

FIG. 25 is an alternative means for providing a threaded member to that shown in FIG. 24.

FIG. 26 illustrates the positioning of PV modules upon a roof for an angled installation relative to the roof.

FIG. 27 is an exploded view of the mating flanges and relationship to the modified “C” Channel support rails having the two additional grooves.

FIG. 28 shows the vertical support member secured to a channel strut.

FIG. 29 is an assembled view of FIG. 27.

FIG. 30 illustrates how the PV module is extended into final position.

FIG. 31 illustrates the final position of FIG. 29.

FIG. 32 illustrates an alternative embodiment incorporating the use of a third support leg.

### DETAILED DESCRIPTION OF THE PREFERRED EMBODIMENT

Incorporated herein is the detailed description from the previous two utility applications referenced above. A Detailed Description pertaining to the new matter presented in this application is identified below.

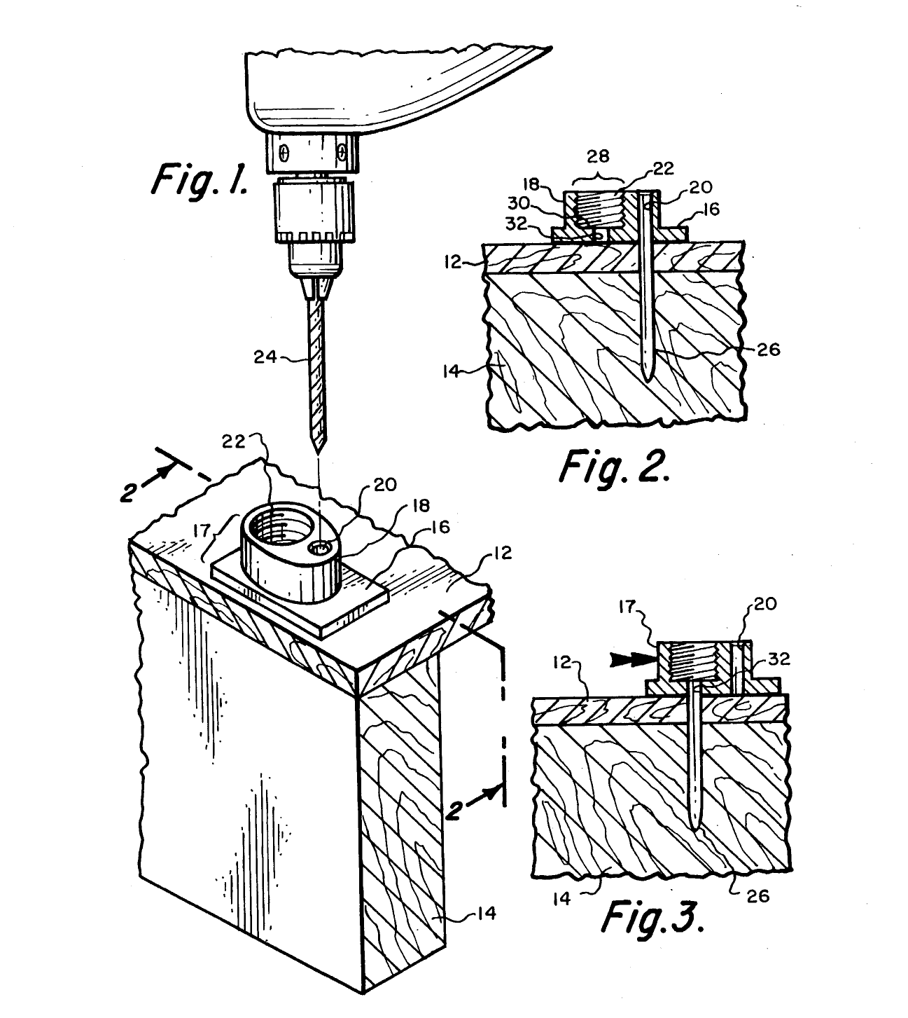

FIG. 1 through FIG. 6 illustrates the sequence for installing my roof mount to a rafter.

FIG. 1 illustrates the general relationship of base section 17 to a roof having decking 12 and rafter 14.

Base section 17 comprises a base 16 and a cylindrical member 18 integral with and extending away from base 16. Cylindrical member 18 has an offset wall area.

As illustrated in FIG. 2, base section 17 has a guide tunnel 20 which extends from the top of cylindrical member 18 to the bottom of base 16. The purpose of guide tunnel 20 is to provide perpendicular alignment of drill bit 24 to rafter 14 for the drilling of pilot hole 26. Perpendicular alignment is important because it minimizes the probability of rafter splits, as can occur when a pilot hole is drilled which is not in perpendicular alignment to the rafter.

Cylindrical member 18 further has a cavity 22, the top of cavity 22 defining an insertion opening 28. The walls of cavity 22 are threaded for engaging a stanchion 42 as will be discussed later.

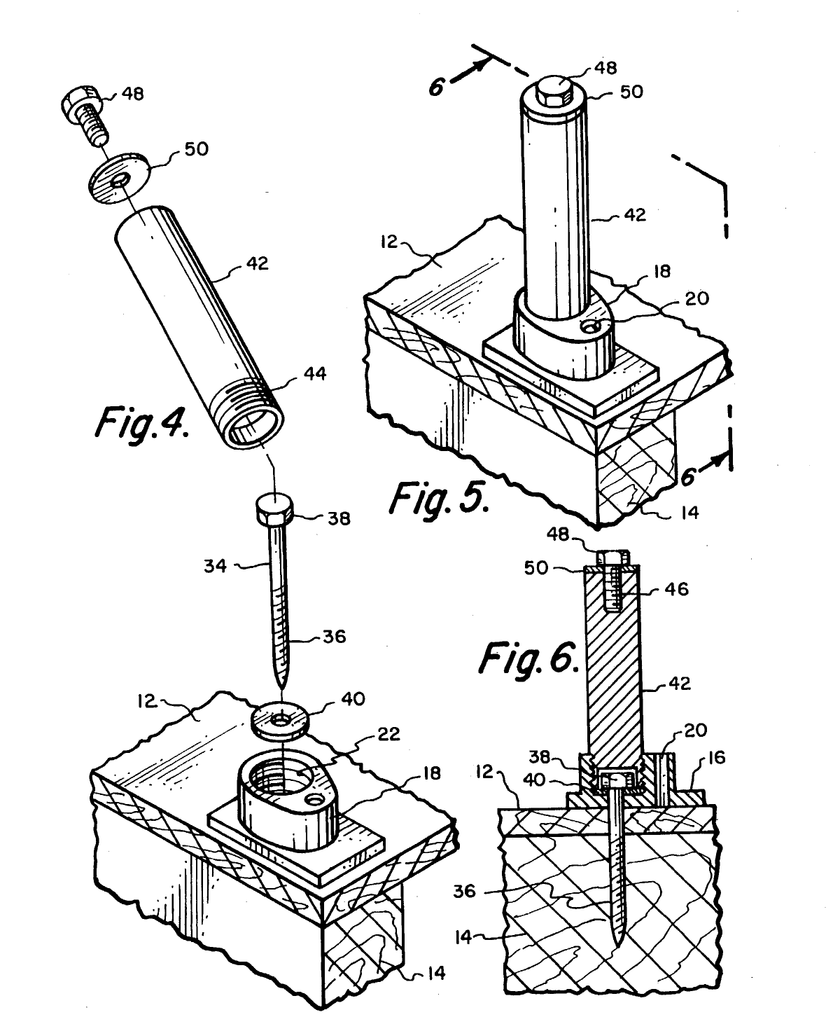

Defining the bottom of cavity 22 is top surface 30. A hole 32 extends from top surface 30 through base 16. Hole 32 has a common axis of symmetry with cavity 22 and is designed to accept the stem 36 of a fastening bolt 34 as shown in FIG. 4.

With the alignment as shown in FIG. 1, drill bit 24 is inserted into guide tunnel 20 and a pilot hole 26 is drilled into rafter 14 as shown in FIG. 2.

Base section 17 is then displaced along decking 12 until pilot hole 26 is aligned with hole 32 as shown in FIG. 3.

FIG. 4 illustrates the relationship of fastening bolt 34 and stanchion 42 to base section 17. Once hole 32 is aligned with pilot hole 26, fastening bolt 34 is inserted through washer 40 and screwed into rafter 14. Fastening bolt head 38 remains within cavity 22. Stanchion 42 has a male threaded end 44 and is inserted through insertion opening 28 for threadable engagement within cavity 22.

Distal from threaded end 44 is female threaded end 46 for frictional engagement of mounting bolt 48 and washer 50. FIG. 5 and FIG. 6 illustrate the assembled roof mount 10 fastened to rafter 14. Roof mount 10 comprises base section 17, stanchion 42 along with threadably connected mounting bolt 40 and washer 50.

In practice, the rafters 14 and decking 12 will be installed prior to the installation of roof mount 10. A single pilot hole 26 is drilled for each roof mount which, due to my design, will be perpendicular to the roof rafter and minimize the risk of rafter split. The number of roof mounts used will be determined by the size of the object to be mounted.

Once the pilot hole is drilled, base section 17 is slid a short distance and fastening bolt 34 is inserted to fasten base section to rafter 14. Again, because only one hole is drilled into the rafter for each roof mount 10, less labor time is required than with typical floor flanges.

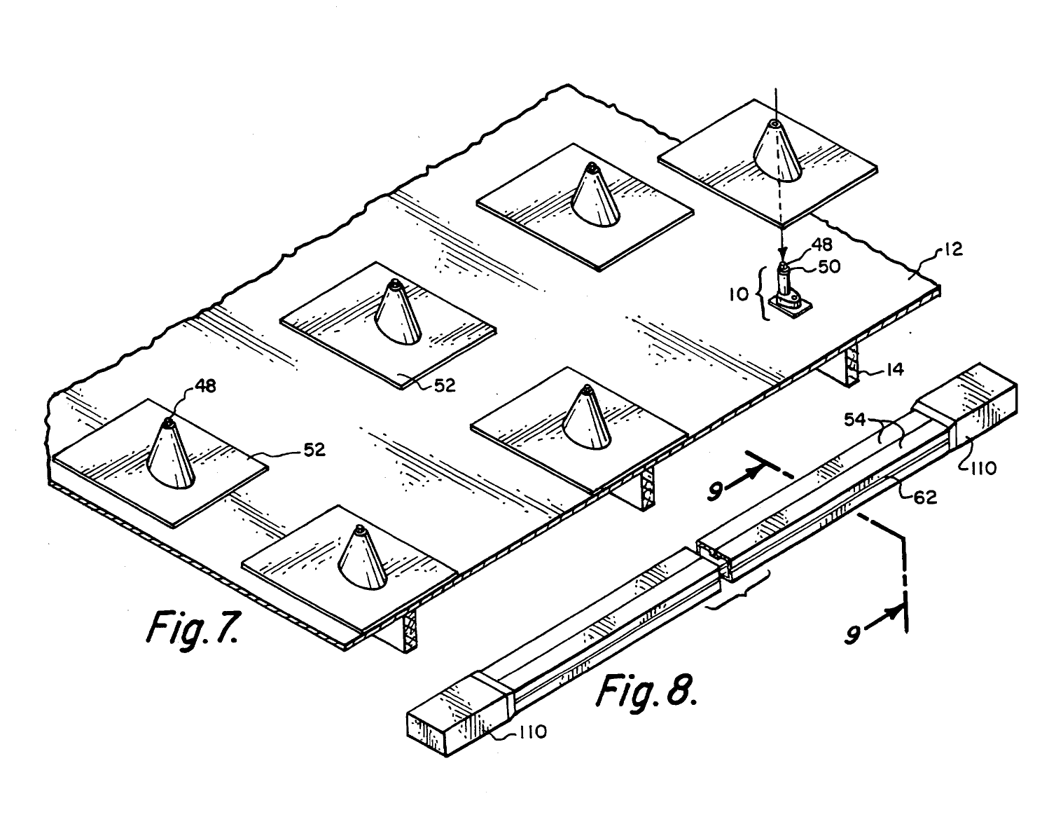

Once all roof mounts 10 have been fastened to their respective rafters, flashing 52 must be installed to protect the roof from the risk of future water damage. FIG. 7 illustrates the arrangement of multiple flashings 52 over a plurality of roof mounts 10. Following flashing installation, the decking 12 is typically layered with roofing material (not shown).

Although my mounting system can be utilized for a variety of objects to be mounted above a roof, the following procedure will address installation of a solar panel having multiple modules.

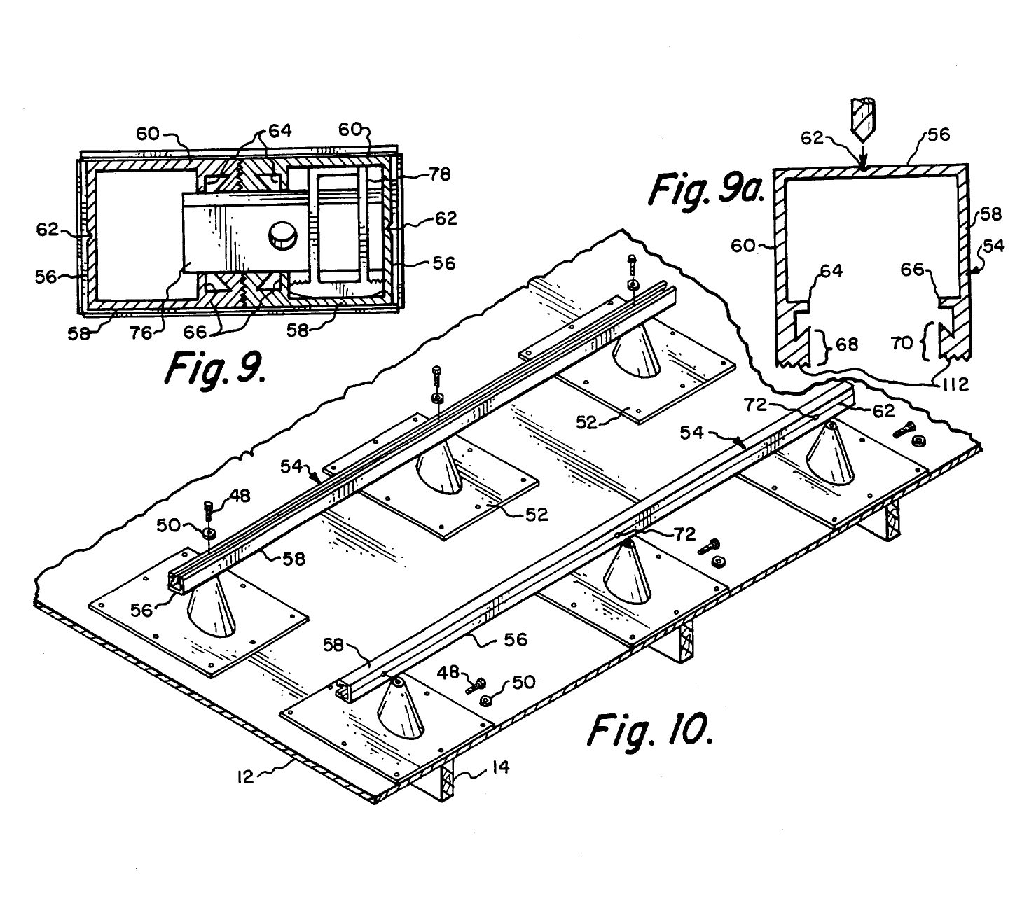

Once the roof is in a condition for installing a solar panel, a pair of C-shaped elongated horizontal members 54 are provided. Each horizontal member 54 has a base wall 56 and a pair of side walls 58 and 60. A linear groove 62 runs along the bottom surface of base wall 56 as can be seen in FIG. 9a and FIG. 10.

FIG. 9a also illustrates a pair of horizontal ledges 64 and 66 extending inward from sidewalls 58 and 60 toward each other. These ledges extend the length of sidewalls 58 and 60. A pair of protruding lips 68 and 70 extend inward from the distal end of sidewalls 58 and 60 relative to base wall 56. A track area is defined by the surface area of ledges 64 and 66 which face lips 68 and 70 respectively. The purpose of the track will be discussed below.

FIG. 10 illustrates the attachment of horizontal members 54 to roof mounts 10. Initially, mounting bolts 48 and washers 50 are removed from stanchions 42. Horizontal member 54 is positioned along each flashing cone. As shown in FIG. 9a, a drill is used to drill mounting holes 72 along groove 62 on base wall 56 for each roof mount. Once the first mounting hole 72 is drilled, additional mounting holes can be drilled by simply measuring the distance from the last hole drilled when the spacing between the rafters is known.

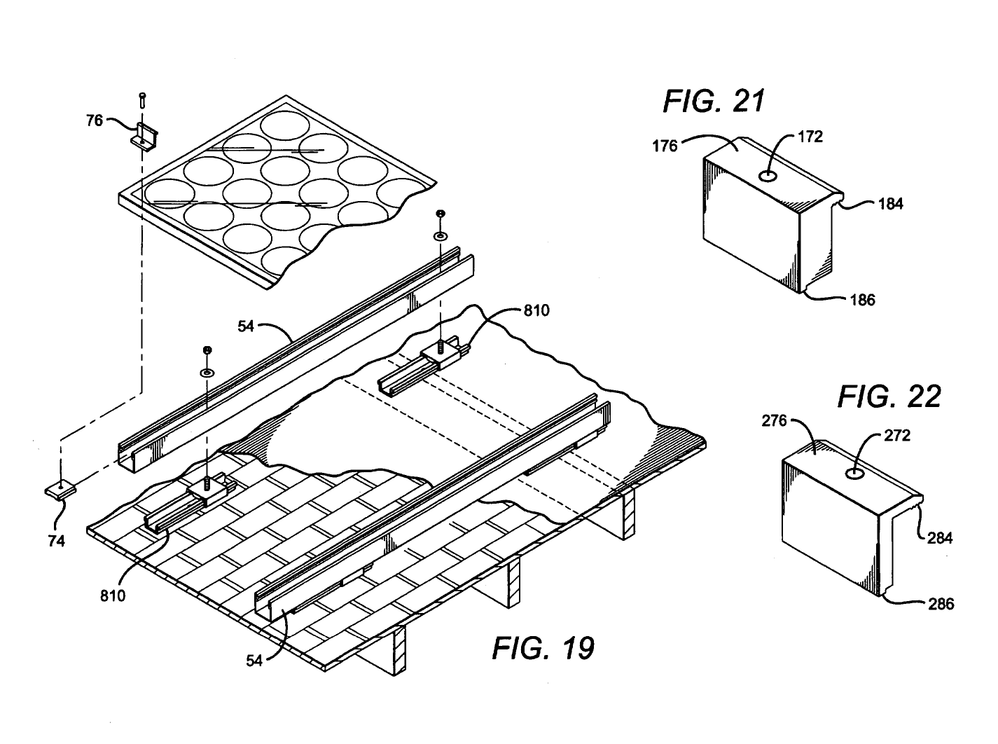

The support means can also be modified to be fastened to an existing roof by use of base mounts 810 as shown in FIG. 19. The attachment means comprises base mount 810 which joins to member 54. An insert is used to threadably sandwich member 54 between the insert and base mount 810 for additional structural support. Alternatively, base mount 810 can be directly bolted to member 54 but this configuration would not provide the structural support as if base mount 810 were bolted to the insert.

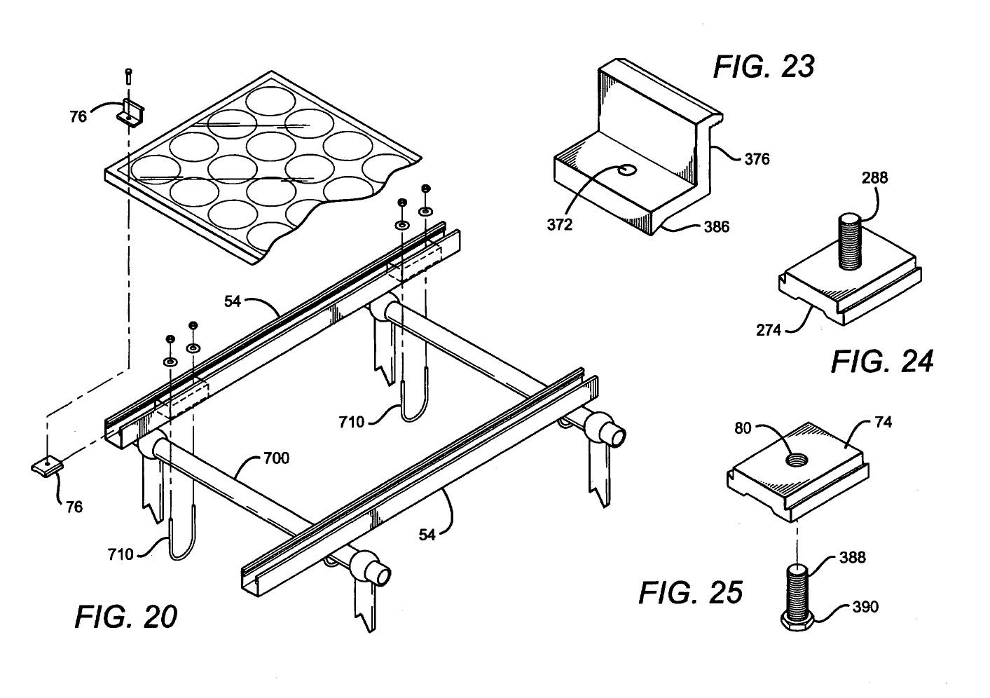

The support means can also be modified to be fastened to ground raking system 700 as shown in FIG. 20. The attachment means comprises a U-shaped member 710 which joins to member 54 having a pipe member there between. The ends of U-shaped member 710 are operatively attached to member 54 by the use of an insert (not shown) which essentially serves as the base mount although located within member 54. Alternatively, U-shaped member 710 can be directly bolted to member 54 but this configuration would not provide the structural support as if U-shaped member 710 were bolted to the insert.

Once all mounting holes 72 have been drilled, horizontal member 54, is positioned the above flashing cones with mounting holes 72 aligned with female threaded end 46. Mounting bolts 48 and washers 50 are then used to frictionally engage horizontal members 54 to respective roof mounts 10. FIG. 11 shows horizontal members 54 assembled to roof mounts 10.

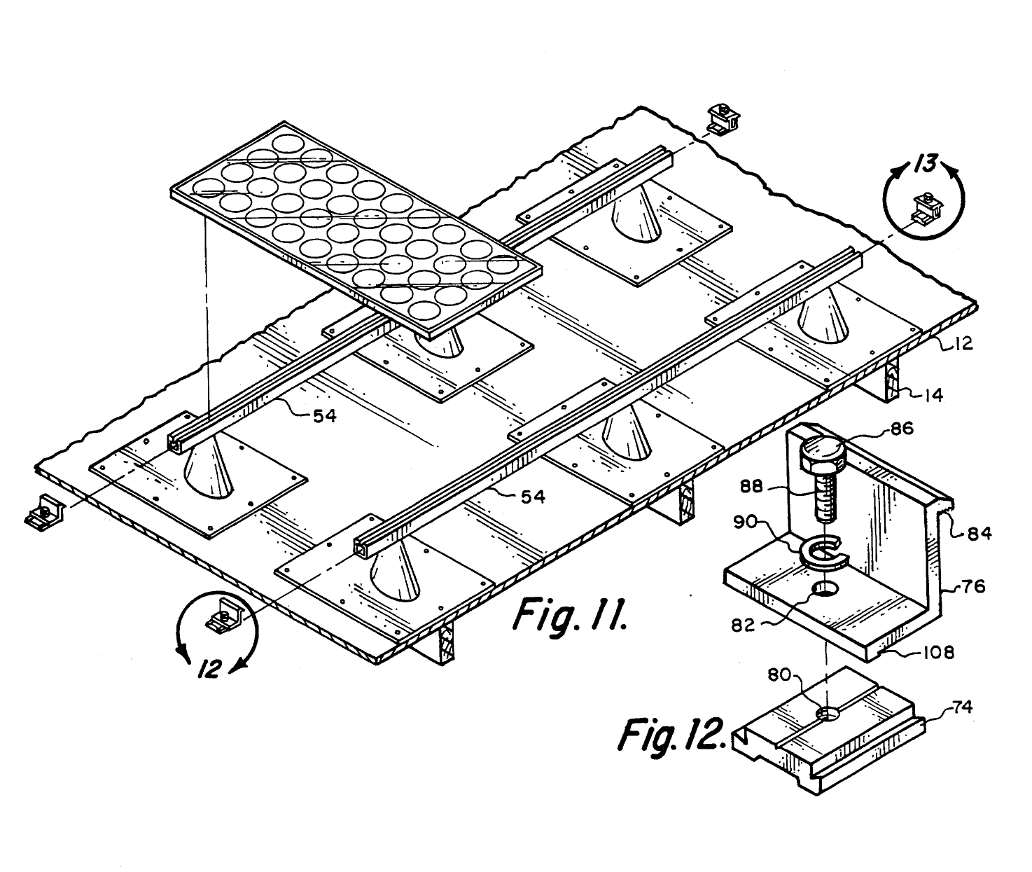

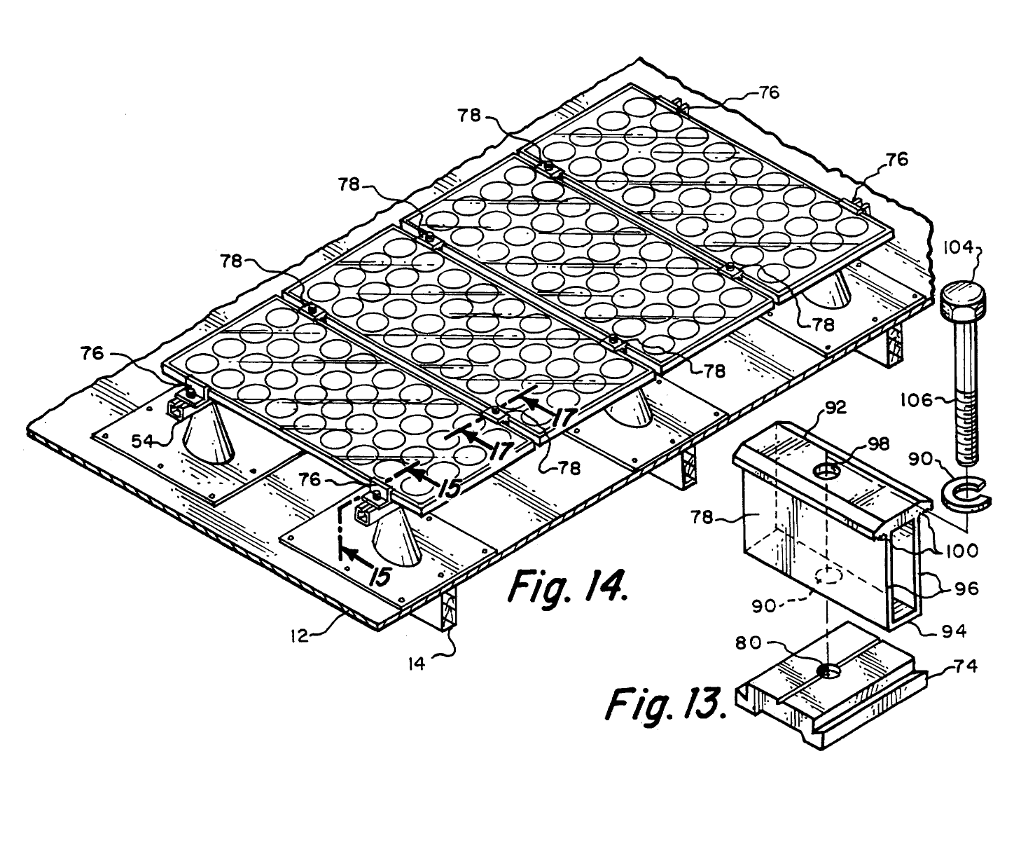

At least two slidable inserts 74 are provided for each horizontal member 54 and a general configuration is illustrated in FIG. 12 and FIG. 13. Insert 74 has a female threaded hole 80. The outer configuration of insert 74 is designed to be slidably received within track area of horizontal member 54. The required number of inserts 74 is dependent upon the number of clamps needed to secure the solar panel. There are two types of clamps available: end clamps 76 and bi-module clamps 78.

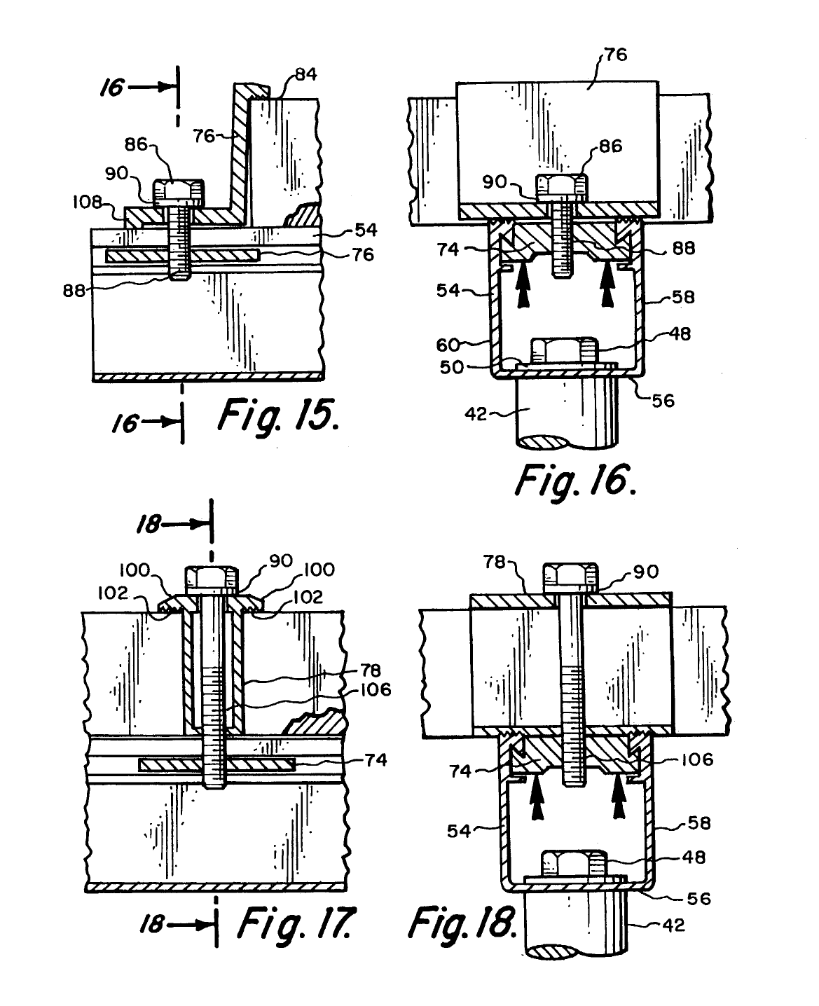

End clamp 76 is illustrated in FIG. 12 and has a hole 82 for alignment with threaded hole 80 on insert 74. End clamp 76 has a notched surface 84 for frictionally engaging the solar panel and securing it between notched surface 84 and horizontal member 54 when end clamp bolt 86 has its threaded stem 88 passed through washer 90 and hole 82 for engagement with threaded hole 80 on insert 74. FIG. 15 and FIG. 16 show the solar panel in frictional engagement between notched surface 84 and horizontal member 54.

Two end clamps 76 are used to secure a solar panel there between and along each horizontal member 54 when each end clamp 76 is threadably fastened to insert 74 using bolt 86. A solar panel is defined as at least one solar module and can be a number of modules in series as illustrated in FIG. 14. Therefore, four end clamps 76 are used to secure a solar panel to two horizontal members 54.

A bi-module clamp 78 is illustrated FIG. 13. They are used to secure the sides of two adjoining solar panel modules and to a horizontal member 54 when bi-module clamp 78 is threadably fastened to insert 74 using a bolt 104. The use of bi-module clamps 78 and end clamps 76 in my mounting system is best illustrated in FIG. 14.

The number of bi-module clamps required for each horizontal member 54 is determined by the formula:

number of bi-module clamps=(number of modules −1).

Each bi-module clamp 78 has a top side 92, a bottom side 94, and a pair of side walls 96. Holes 98 located on top side 92 and bottom side 94 have a common axis of symmetry and are for alignment with threaded hole 80 on insert 74. Top side 92 extends perpendicularly away from side walls 96 in either direction forming overhangs 100 having notched surfaces 102. Notched surfaces 102 are for frictionally engaging the solar module and securing it between notched surface 102 and horizontal member 54 when bolt 104 has its threaded stem 106 passed through washer 90 and holes 98 for engagement with threaded hole 80 on insert 74. FIG. 17 and FIG. 18 show a pair of solar modules in frictional engagement between notched surfaces 102 and horizontal member 54.

As a slidable insert 74 is threadably engaged and frictionally positions either bi-module clamp 78 or end clamp 76 along member 54, insert 74 also frictionally engages an area of member 54. This relationship is illustrated in FIG. 16 and FIG. 18. This engagement changes the structural properties of member 54 to that of a structural square for enhanced strength. In addition, when engaged to the module or solar panel frame, the structural properties of the module frame combine with horizontal member 54 and form a rigid inter-locking trussed cross-section.

Alternatives to that shown in FIG. 12 are shown in FIG. 24 and FIG. 25. Rather than having a bolt with a threaded stem which threads downward into insert 74, FIG. 24 shows a slidable insert 274 having an upward rising threaded stem 288. FIG. 25 shows insert 74 where bolt 390 having male stem 388 is screwed into from below to have the same final configuration as that shown in FIG. 24.

Each end clamp 76 has a heal means, or slight rise 108 on its bottom surface distally positioned from its clamping surface and is illustrated in FIG. 12 and FIG. 15. Rise 108 prevents end clamp 76 from twisting while fastening bolt 86 to insert 74.

Alternative designs to end clamp 76 shown in FIG. 12 are presented in FIG. 21 and FIG. 22. Rather than having an aperture located on the portion of the clamp which contacts member 54 as is the case for clamp 76, apertures 172 and 272 for end clamps 176 and 276 shown respectively in FIG. 21 and FIG. 22 are located on the horizontal portion which includes notched surface 184 and 284. Alternative end clamps 176 and 276 also incorporate a heel means, or raised heels 186 and 286 respectively.

Besides the heel means of the end clamp designs mentioned which incorporate a heel, an alternative heel means, which performs the same function as a unitized heel, i.e. preventing the twisting of the end clamp while being secured to horizontal member 54 and forcing the clamp inward at 90 degrees to fully engage the object by the notched surface can be accomplished with the combination shown in FIG. 23. Here, end clamp 376 can be the same design as for end clamp 76 but excluding heel portion 108. The function of the heel is performed by a second item, denoted as wedge 386. The width of wedge 386 must be sufficient so it will contact both top sides of member 54. Alternatively, a pair of smaller wedges can be positioned on each top side of member 54 directly below end clamp 376 to provide the proper inward angle toward the object to grip.

As stated earlier, the securing means, besides being an end clamp having a heel, can also be an end clamp not having a heel used in combination with a wedge or half-moon shaped washer or other protrusion that, when positioned between the bottom side of the end clamp and the top surface of the horizontal member, will provide the same inward force against the object when tightened to the horizontal support rail.

As best illustrated in FIG. 14, horizontal members 54 along with the associated component parts, namely slidable inserts 74, end clamps 76 and bi-module clamps 78 and the attachment means to roof mount 10 comprise a solar panel support structure.

FIG. 8 illustrates the unitized packaging for the mounting components, namely a pair of horizontal members 54 and the associated number of inserts 74, bi-module clamps 78, and a pair of end clamps 76. The ends of the horizontal members 54 are secured by tape or other packaging material 110. Packaging material 110 not only maintains the relationship of horizontal members 54 to one another, it also prevents the inserts and clamps from escaping.

As can be best seen in FIG. 9a, the outward facing surface 112 of the open side of horizontal member 54 has ridges. These ridges extend the length of each member 54 and form mating or interlocking surfaces when the open sides of two horizontal members 54 are aligned and contacted with one another. FIG. 9 illustrates two horizontal members 54 mated to one another and show a bi-module clamp 78 and an end clamp 76 in view.

During assembly, the inserts and clamps are placed into a horizontal member 54. Packing such as paper (not shown) is also inserted to prevent the inserts and clamps from excessive movement and potential wear and damage. The second horizontal member 54 is thereafter mated to the other member by cooperatively engaging along surfaces 112. Outside packaging is thereafter used to seal the open ends.

### DETAILED DESCRIPTION OF NEW MATTER PRESENTED

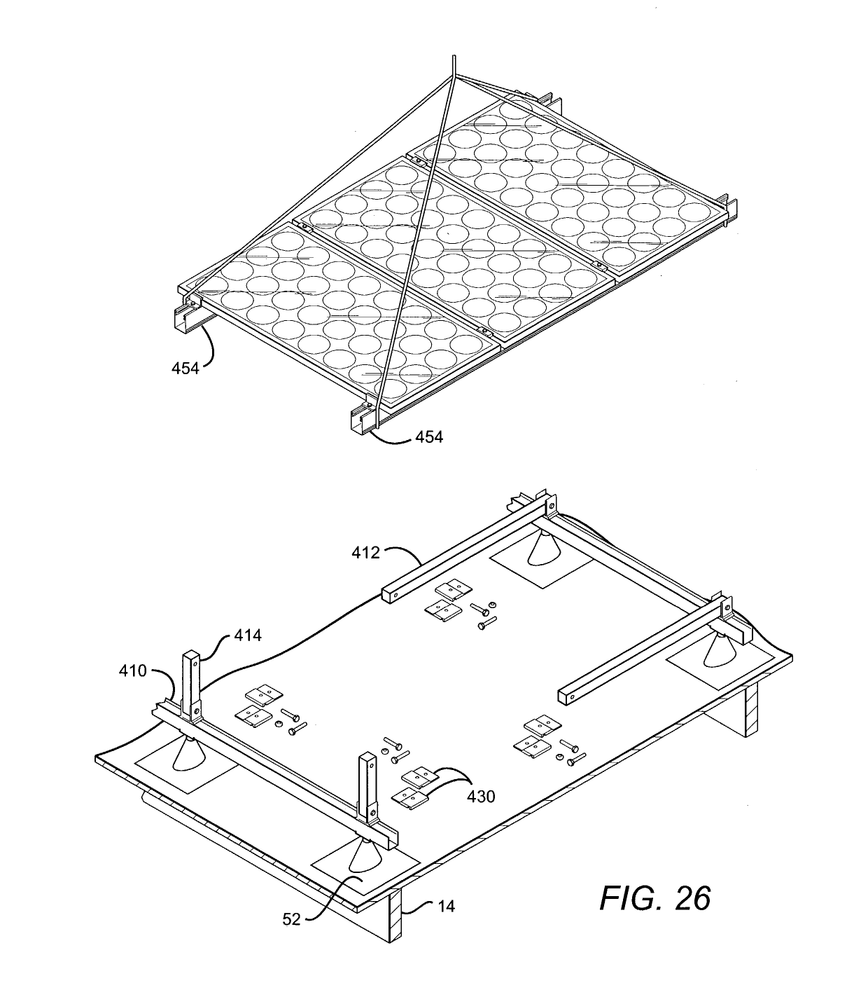

For assembly to a commercial rooftop, the procedure presented in FIGS. 1-7 is applicable. Due to the increased distance between rafters for a commercial rooftop, rather than using the horizontal members 54 illustrated in FIG. 10, channel struts 410, preferably made from a corrosion resistant plated steel are attached to base mounts as shown in FIG. 26 by the attachment means described earlier.

Referring again to FIG. 26, each channel strut 410 will typically support a pair of support legs for each solar panel. One channel strut will support a longer pair of support legs 412 and the other channel strut will support a shorter pair of support legs 414. The difference in length between the pair of support legs 412 and 414 accounts for the desired angle of the solar panel installation.

Referring to FIG. 28, each support leg is attached to a corresponding channel strut 410 by the use of a lower support bracket 416 which, in a preferred embodiment, has a serrated bottom surface 418 for enhanced frictional contact with channel strut 410 as it is secured in place. An aperture 419 in the bottom wall of channel strut 410 permits a bolt (not shown) to threadably engage to a slidable insert (not shown) within channel strut 410 in the same manner as end clamp 76 is secured to horizontal member 54 in FIGS. 11 and 12.

Support legs 412 and 414 have a pair of apertures 420 having a common axis of symmetry with corresponding apertures 422 on lower support bracket 416 to facilitate operable attachment by using a threaded bolt 424 or the like.

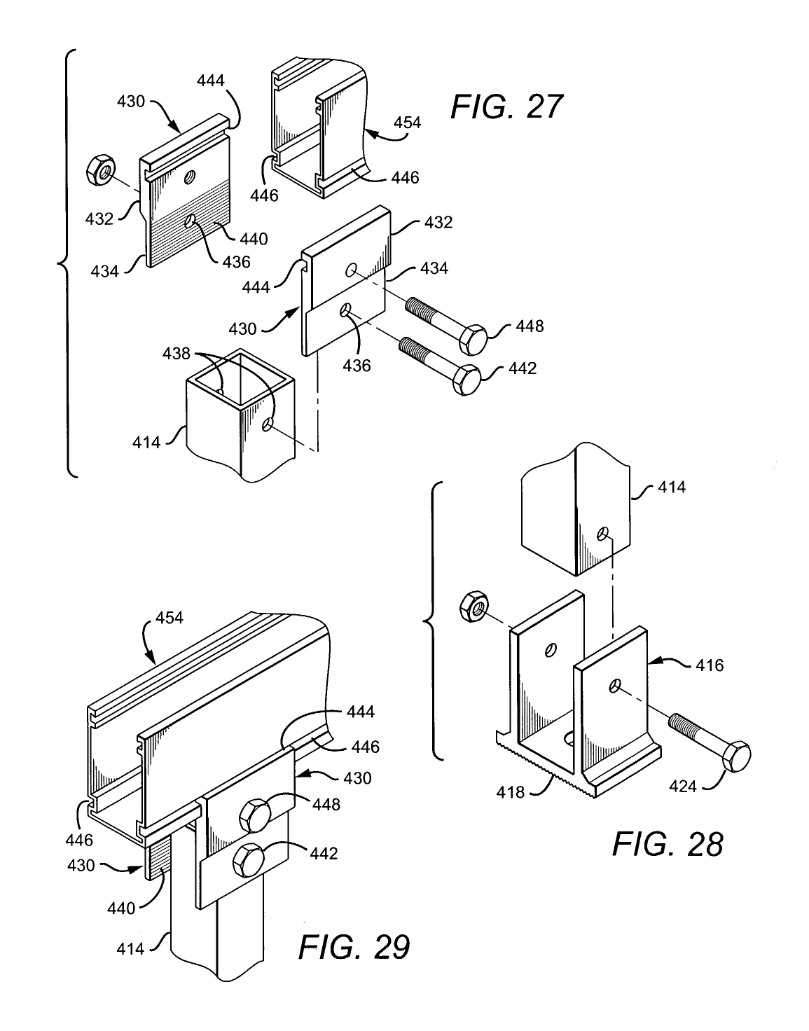

Referring to FIG. 27, the top portion for both support legs 412 and 414 is bolted to a pair of flange brackets 430 mounted on opposing sides of a support leg. Each flange bracket 430 is comprised of a thicker top section 432 and a thinner lower section 434. A pair of lower sections 434 is bolted to either support leg 412 or 414 by apertures 434 and 438. In a preferred embodiment, lower section 434 of flange bracket 430 has a serrated surface 440 opposing the support leg to enhance frictional engagement when secured by bolt 442.

Upper section 432 has a lip 444 running the entire length and is sized to slidably engage a respective elongated slot 446 present on module support rail 454.

Module support rail 454 is identical to horizontal support member 54 except that it further comprises a pair of elongated slots 446. The securing means of the PV modules to module support rails 454 is the same as previously described to horizontal support members 54 which are illustrated in FIGS. 11-25.

As illustrated in FIG. 26, the solar panels and module support rails 454 are hoisted upon the commercial roof. For each solar panel, the corresponding pairs of long and short support legs 412 and 414 are raised to a vertical position. Lips 444 for corresponding flange brackets 430 are operatively fitted within elongated slots 446. Flange brackets 430 and module support rail 454 are then secured by threaded bolt 448. Then, lower sections 434 of flange brackets 430 are secured to the top part of support legs 412 or 414 by threaded bolt 442. Since lip 444 of each flange bracket 430 snugly fits within an elongated slot 446, the design avoids the creation of a hinge point thereby providing a more secure and stable attachment. The final attachment of module support rail 454 to support leg 412 or 414 is illustrated in FIG. 29.

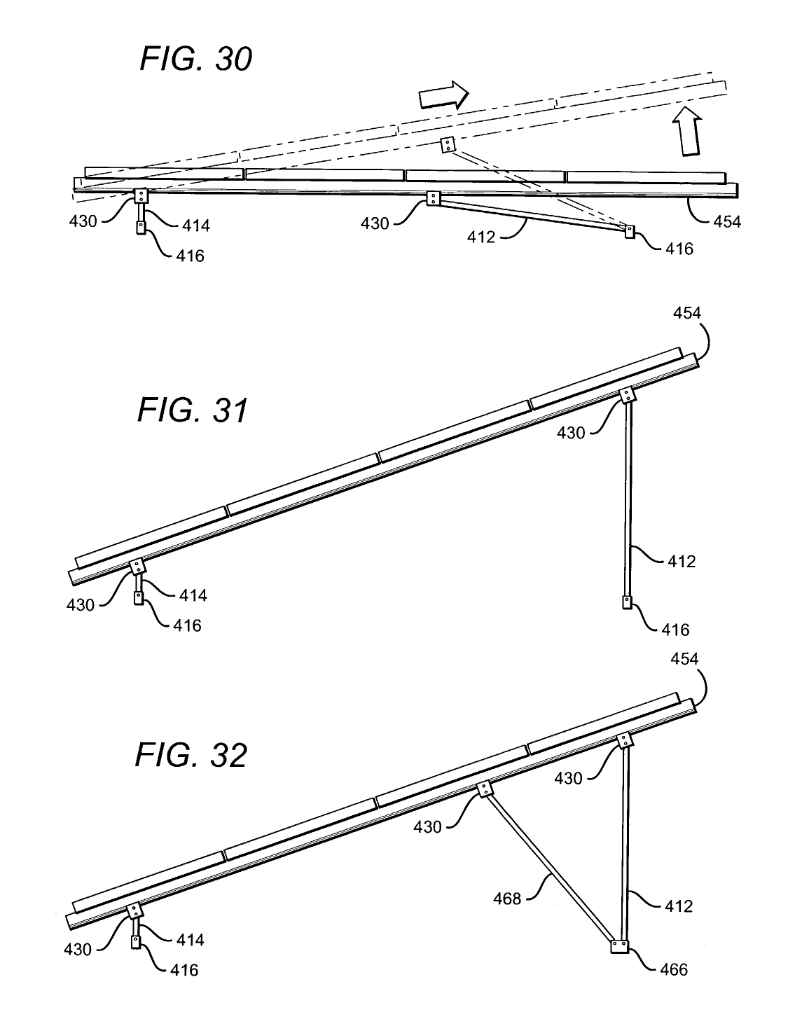

FIGS. 30 and 31 illustrate the elevating procedure of the solar panel assembly to final position once the module support rails 454 are functionally secured to the rooftop.

FIG. 32 illustrates an alternative embodiment incorporating the use of a third support leg 468. For this embodiment, lower support bracket 466 is a modified version of bracket 416 to include an additional pair of apertures to secure the lower end of leg 468 similar to leg 412. An additional pair of flange brackets 430 is provided to secure the top portion of third leg 468 to module support rail 454 thereby providing a additional load bearing member to support the solar panel assembly.

I claim:

1. A mounting system for mounting an object above a commercial roof having flashing and fastened to two support beams, said mounting system comprising:
a) at least two roof mounts for fastening to a respective support beam, each roof mount comprising:
a base and an integrated hollow cylinder, said cylinder having an offset wall and an insertion opening pointing away from the roof; an alignment means for ensuring that a pilot hole drilled into a rafter will be drilled at a perpendicular angle to the rafter; and a means for fastening the base to a rafter;
b) at least two stanchions having a top end and a bottom end, said bottom end being fitted into a respective insertion opening of a base section, thereby orientating said stanchion away from the roof, each of said stanchions being of sufficient length to extend at least to the top of the flashing material;
c) at least one channel strut positioned upon two stanchions; and,
d) support means for an object; said support means operatively positioned upon at least two channel struts.

2. The mounting system of claim 1 wherein said alignment means is a guide tunnel formed in said offset wall and said base whereby said guide tunnel can receive a drill bit for drilling a pilot hole into a rafter.

3. The mounting system of claim 1 wherein said means for fastening comprises a hole extending from the hollow cylinder through said base so that a single lag bolt may be received through said insertion opening and fasten a base to a roof rafter.

4. The mounting system of claim 1 wherein said support means comprises at least one module support rail having a pair of elongated tapered slots along outer opposing sides and a pair of vertically extending support legs operatively connected to each channel strut where said support legs are of different lengths operatively connected to each, where said module support rail is operatively connected to each of said support legs by a respective pair of flange brackets.
